(19) United States
(12) Patent Application Publication
(10) Pub. No.: US 2017/0173621 A1
(43) Pub. Date: Jun. 22, 2017

(54) ULTRASONIC-ROTARY COMPOSITE ATOMIZATION MECHANISM

(71) Applicant: Precision Machinery Research Development Center, Taichung City (TW)

(72) Inventors: CHIN-PO YANG, Chiayi City (TW); PEI-KUN LIN, Chiayi City (TW); WANG-LIN LIU, Chiayi City (TW)

(21) Appl. No.: 14/979,026

(22) Filed: Dec. 22, 2015

(51) Int. Cl. B05B 17/06; B05B 3/10; B05B 3/14

(52) U.S. Cl. CPC B05B 17/0653; B05B 3/14; B05B 3/1014

(57) ABSTRACT

An ultrasonic-rotary composite atomization mechanism comprises a housing and an ultrasonic unit passing through the housing and free to rotate with respect to the housing. A dynamic unit is installed in a position of the ultrasonic unit, which is corresponding to the housing, to drive the ultrasonic unit to rotate with respect to the housing. The ultrasonic unit includes a material supply channel, a vibration member disposed in the ultrasonic unit, and a vibration-rotation cup connected with the material supply channel. The material supply channel carries a liquid into the vibration-rotation cup. The dynamic unit and vibration member operate simultaneously to make the vibration-rotation cup rotate at high speed and vibrate ultrasonically. Thus is generated a synergistic effect: the ultrasonic vibration uses inertia force to break the cohesion and disperse the liquid, and the high-speed rotation generates centrifugal force to atomize the liquid.

### FIELD OF THE INVENTION

The present invention relates to an atomization technology, particularly to an ultrasonic-rotary composite atomization mechanism.

### BACKGROUND OF THE INVENTION

Atomization is to disperse liquid into suspension particles, usually applied to agriculture, lowering the environmental temperature, and spraying paint. The conventional atomization technologies include the ultrasonic atomization technology, the rotary atomization technology, and the high-pressure atomization technology. A US patent publication No. US 2009/0061089 disclosed an ultrasonic atomization technology, wherein ultrasonic vibration applies force to liquid along the vibration direction to generate H-shape minute ripples on the surface of the liquid. While the intensity of the sound waves is increasing, the ripples gradually rise to form tiny liquid columns. Then, singularity points appear in the tiny liquid columns. Finally, the liquid columns break at the singularity points, and the tops of the liquid columns become liquid droplets, and the liquid droplets are projected out. The ultrasonic atomization technology is suitable for a medium-viscosity liquid. Compared with the rotary atomization technology and the high-pressure atomization technology, the ultrasonic atomization technology has a higher spray utilization rate and is economical in material. However, the ultrasonic atomization technology has a lower atomization rate and a lower productivity.

A U.S. Pat. No. 8,602,326 disclosed a rotary atomization technology, which uses a high-speed rotary disc to apply centrifugal force to liquid coating material, breaking the cohesion of the liquid, generating throat-like singularity points, and then atomizing the liquid. The higher the rotation speed, the finer the liquid droplets. The conventional technology can process coating materials having higher stickiness. The rotary atomization technology has a medium atomization productivity and is suitable to atomize higher-viscosity liquids. Compared with the ultrasonic atomization technology and the high-pressure atomization technology, the rotary atomization technology has an appropriate spray utilization rate but suffers from high equipment depreciation caused by high speed rotation and shorter service life of equipment.

A Taiwan patent No. 1374066 disclosed a high-pressure atomization technology, which pressurizes a liquid to pass through a nozzle. The design of the flow channel of the nozzle causes collision of the liquid and atomizes the liquid. Compared with the ultrasonic atomization technology and the rotary atomization technology, the high-pressure atomization technology has a higher atomization productivity and applies to high-viscosity liquids. However, the high-pressure atomization technology has a lower spray utilization rate and suffers from that the small flow channel thereof is likely to be blocked.

All the abovementioned technologies can atomize liquid. Because of lower spray utilization rate, the high-pressure atomization technology is unsuitable to high-price functional liquids but usually applies to cheaper liquids, such as water and ordinary paint materials. Featuring low material loss, the ultrasonic atomization technology is pretty suitable to high-price functional materials. However, the ultrasonic atomization technology is inferior in atomization rate and hard to meet the requirement in productivity. The ultrasonic atomization technology can uses higher vibration frequency to atomize high-viscosity liquids. However, the higher the vibration frequency for atomization, the lower the atomization rate (the quantity of the liquid atomized during a unit time interval). Further, the equipment of the ultrasonic atomization technology is expensive and has a shorter service life. Apparently, the ultrasonic atomization technology is hard to meet requirement in atomization efficiency. The rotary atomization technology has an appropriate spray utilization rate and is suitable to atomize high-viscosity liquids. The atomization efficiency of the rotary atomization technology is proportional to the rotation speed. Compared with a low-viscosity liquid, such as water, a sticky liquid needs a higher rotation speed to achieve the same atomization efficiency. However, high rotation speed leads to high depreciation and implies higher equipment cost, shorter service life and lower reliability. Therefore, the rotary atomization technology is also hard to satisfy requirements in application.

### SUMMARY OF THE INVENTION

The primary objective of the present invention is to disclose an ultrasonic-rotary composite atomization mechanism, which uses two different atomization principles simultaneously to achieve a synergistic atomization effect, whereby to increase atomization efficiency and satisfy requirement in application.

To achieve the abovementioned objective, the present invention proposes an ultrasonic-rotary composite atomization mechanism, which comprises a housing and an ultrasonic unit passing through the housing and free to rotate. The housing has an inlet and an outlet. A dynamic unit is installed in a position of the ultrasonic unit, which is corresponding to the housing, to drive the ultrasonic unit to rotate with respect to the housing. The ultrasonic unit includes a material supply channel with an entrance and an exit, a vibration member disposed in the ultrasonic unit, and a vibration-rotation cup disposed in the exit with a terminal thereof closely neighboring the outlet. The exit of the material supply channel closely neighbors the outlet, and the entrance of the material supply channel closely neighbors the inlet.

Thereby, the liquid to be atomized flows through the inlet and the entrance, passes through the material supply channel and then enters the vibration-rotation cup. The vibration member enables the vibration-rotation cup to vibrate ultrasonically, whereby the inertia force drags the liquid reciprocally to disperse the liquid. Meanwhile, the dynamic unit rotates the vibration-rotation cup at high speed to centrifugate the liquid and then atomize the liquid. The present invention uses the rotary atomization technology and the ultrasonic atomization technology simultaneously to atomize a liquid and thus achieves a synergistic atomization effect. Therefore, the present invention can improve the productivity, reduce the burden of the equipment, and satisfy the requirement in application.

### BRIEF DESCRIPTION OF THE DRAWINGS

FIG. 1 is a perspective view schematically showing the structure of an ultrasonic-rotary composite atomization mechanism according to one embodiment of the present invention;

FIG. 2 is a perspective exploded view schematically showing the structure of an ultrasonic-rotary composite atomization mechanism according to one embodiment of the present invention;

FIG. 3 is a sectional view schematically showing the structure of an ultrasonic-rotary composite atomization mechanism according to one embodiment of the present invention; and

FIG. 4 is a sectional view schematically showing the application of an ultrasonic-rotary composite atomization mechanism according to one embodiment of the present invention.

### DETAILED DESCRIPTION OF THE PREFERRED EMBODIMENTS

The technical contents of the present invention will be described in detail in cooperation with drawings below.

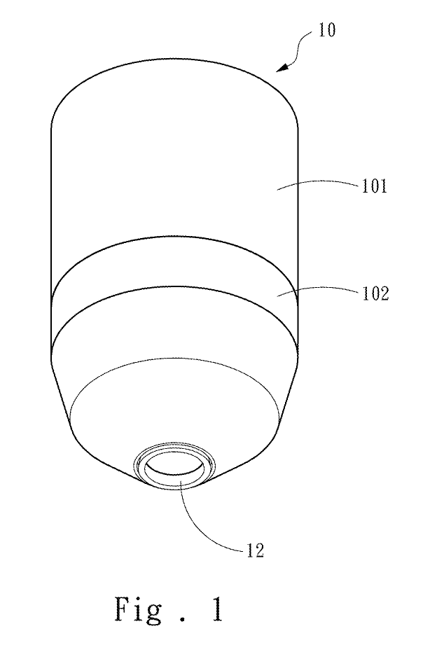

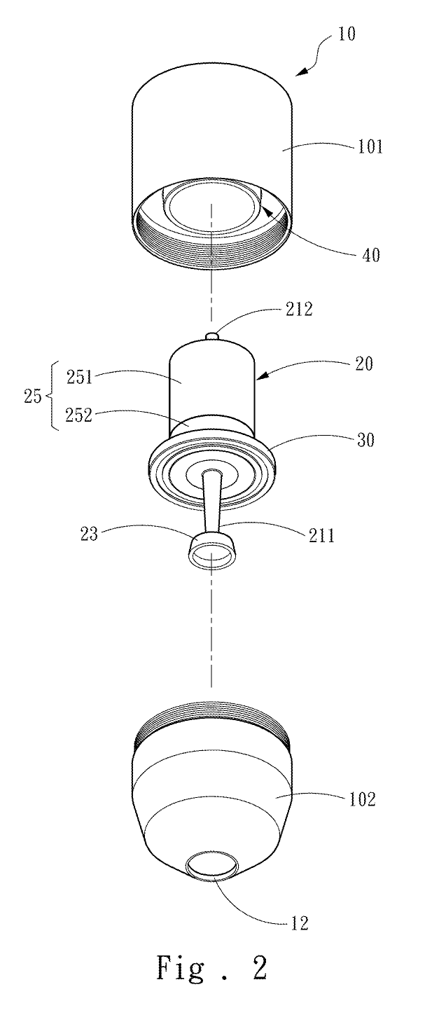

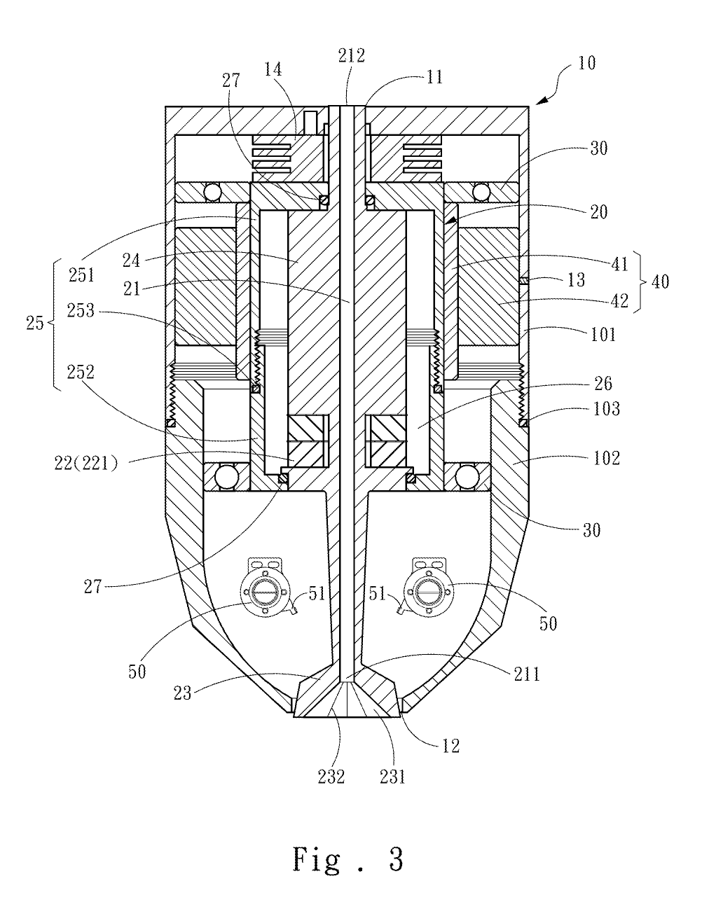

Refer to FIGS. 1-3. The present invention proposes an ultrasonic-rotary composite atomization mechanism, which comprises a housing 10 and an ultrasonic unit 20 passing through the housing 10 and free to rotate with respect to the housing 10. The housing 10 includes an inlet 11 and an outlet 12. The housing 10 includes an upper housing 101 and a lower housing 102, which can be screwed together, whereby the fabrication difficulty can be decreased. A water-proof ring 103 is disposed between the upper housing 101 and the lower housing 102 to prevent humidity from entering the housing 10.

At least one ball bearing 30 is disposed between the housing 10 and the ultrasonic unit 20, whereby the ultrasonic unit 20 is free to rotate with respect to the housing 10. Considering the stability of rotation, two ball bearings 30 are respectively disposed at two ends of the ultrasonic unit 20 in one embodiment.

A dynamic unit 40 is installed in a position of the ultrasonic unit 20, which is corresponding to the housing 10, to drive the ultrasonic unit 20 to rotate with respect to the housing 10. In one embodiment, the dynamic unit 40 includes a permanent magnet 41 disposed in the ultrasonic unit 20 and a brushless motor magnetic coil 42 disposed in the housing 10. In order to supply power to the dynamic unit 40, a brushless motor contact 13 is disposed in the housing 10, penetrating the housing 10, exposed from the housing 10, and electrically connected with the brushless motor magnetic coil 42. An external power source (not shown in the drawings) can be connected with the brushless motor contact 13 to power the dynamic unit 40.

The ultrasonic unit 20 includes a material supply channel 21 with an entrance 212 and an exit 211, a vibration member 22 disposed in the ultrasonic unit 20, and a vibration-rotation cup 23 disposed in the exit 211 with a terminal thereof closely neighboring the outlet 12. The exit 211 of the material supply channel 21 closely neighbors the outlet 12, and the entrance 212 of the material supply channel 21 closely neighbors the inlet 11. In one embodiment, the vibration member 22 involves a piezoelectric ceramic element 221. After receiving an alternating current, the piezoelectric ceramic element 221 oscillates fast and generates vibration. In order to supply power to the piezoelectric ceramic element 221, a rotary electrode 14 is disposed between the housing 10 and the ultrasonic unit 20 and electrically connected with the piezoelectric ceramic element 221 via a circuit (not shown in the drawings), whereby power can be supplied to the piezoelectric ceramic element 221.

In one embodiment, the ultrasonic unit 20 includes a column 24 and a protection shell 25 sleeving the column 24, whereby to protect the vibration member 22. An accommodation room 26 is formed between the column 24 and the protection shell 25 for accommodating the vibration member 22. The material supply channel 21 penetrates the column 24 with the entrance 212 and the exit 211 respectively formed at two sides of the column 24. In one embodiment, O-rings 27 are respectively disposed at two sides of the vibration member 22 and between the column 24 and protection shell 25 to make the accommodation room 26 airtight lest humidity enter the accommodation room 26 and damage the vibration member 22. In one embodiment, the protection shell 25 includes an upper protection shell 251 and a lower protection shell 252, which can be screwed together to form the protection shell 25. In one embodiment, a water-proof ring 253 is disposed between the upper protection shell 251 and the lower protection shell 252 lest humidity enter the protection shell 25.

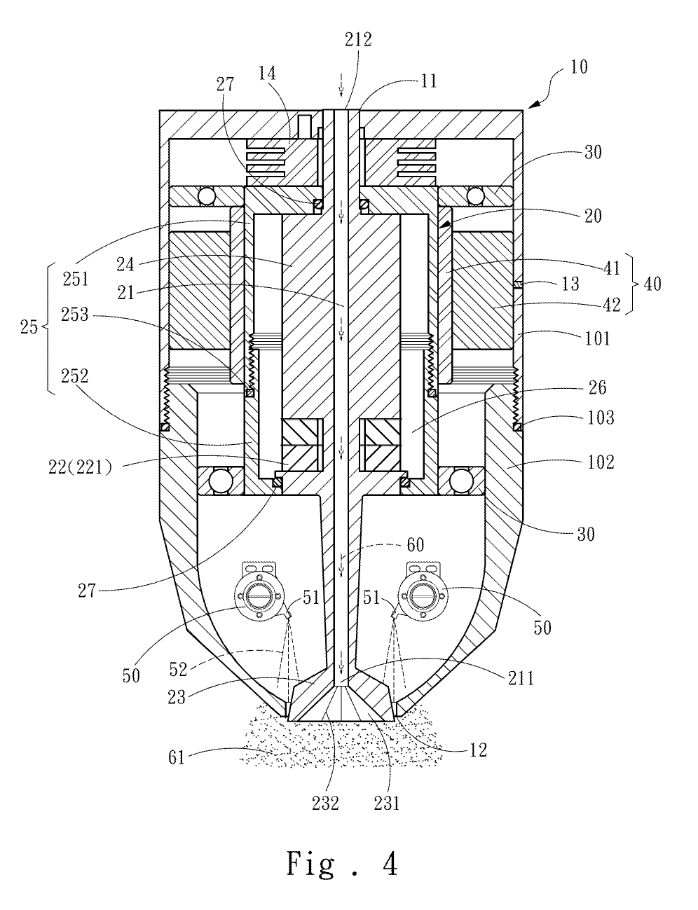

Refer to FIG. 4 also. A liquid 60, which is to be atomized, is filled from the inlet 11 into the entrance 212, flows through the material supply channel 21, leaves the exit 211, and enters the vibration-rotation cup 23. Then, the vibration-rotation cup 23 rotates and vibrates the liquid 60 into suspension particles 61. In order to increase the atomization efficiency, the diameter of the material supply channel 21 gradually shrinks from the entrance 212 to the exit 211. Via the design of the gradually-shrinking material supply channel 21, the flowing speed of the liquid 60 inside the material supply channel 21 is increased to enhance the atomization efficiency.

The vibration-rotation cup 23 includes an inner surface 231 connected with the exit 211. The contour of the inner surface 231 is a hemisphere or a cone. The inner surface 231 is exemplified by a cone in the drawings. The rim of the inner surface 231 closely neighbors the outlet 12. In one embodiment, the inner surface 231 includes a plurality of stripes 232. The stripes 232 can decrease the rotation speed required to generate throat-like singularity points of the liquid 60. In one embodiment, the housing 10 includes at least one airflow guiding device 50 thereinside to control the direction of the atomized flow. The airflow guiding device 50 includes an air nozzle 51 facing the outlet 12. The air nozzle 51 jets out a guiding air blow 52 to fast carry away suspension particles 61 generated by atomizing the liquid 60.

In conclusion, the present invention at least has the following advantages:

1. The vibration member of the present invention enables the vibration-rotation cup to generate ultrasonic vibration, whereby the inertia force drags the liquid and breaks the cohesion thereof to disperse the liquid. Meanwhile, the dynamic unit of the present invention drives the vibration-rotation cup to rotate at high speed to atomize the liquid coating material centrifugally. The present invention uses the rotary atomization technology and the ultrasonic atomization technology simultaneously to achieve a synergistic atomization effect and enhance the atomization efficiency. Further, the present invention needs neither high-speed rotation nor high-frequency vibration. Therefore, the present invention not only promotes the productivity of atomization but also reduces the burden of equipment. Thus, the present invention can satisfy requirement to atomization efficiency with the equipment depreciation being reduced.

2. The synergistic atomization effect of the present invention can reduce the diameter of the suspension particles generated by atomizing the liquid. Thus is increased the density of the coating film and enhanced the control of the film thickness.

3. The protection shell and the O-rings of the present invention effectively prevents the vibration member from be damaged by humidity and prolongs the service life of the atomization equipment.

4. The protection shell and the housing of the present invention are separate components. Thus, the present invention can effectively reduce the fabrication difficulty and satisfy requirement in application.

5. The airflow guiding device of the present invention generates a guiding air blow to effectively control the direction of the suspension particle flow and convenience the operation of painting and coating.

6. In the present invention, the material supply channel whose diameter gradually shrinks from the entrance to the exit and the vibration-rotation cup whose inner surface has stripes can effectively increase the atomization efficiency.

The present invention has been described in detail with the embodiments above. However, these embodiments are only to exemplify the present invention but not to limit the scope of the present invention. Any equivalent modification or variation according to the claims of the present invention is to be also included within the scope of the present invention.

1. An ultrasonic-rotary composite atomization mechanism comprising:
a housing including an inlet and an outlet; and
an ultrasonic unit passing through the housing and free to rotate with respect to the housing, wherein a dynamic unit is installed in a space, which is formed between a part of the ultrasonic unit in the housing and a gap formed by the housing, to drive the ultrasonic unit to rotate with respect to the housing, and wherein the ultrasonic unit includes a material supply channel with an entrance and an exit, a vibration member disposed in the ultrasonic unit, and a vibration-rotation cup disposed in the exit with a terminal thereof closely neighboring the outlet, and wherein the exit of the material supply channel closely neighbors the outlet, and the entrance of the material supply channel closely neighbors the inlet.

2. The ultrasonic-rotary composite atomization mechanism according to claim 1, wherein at least one ball bearing is disposed between the housing and the ultrasonic unit) to make the ultrasonic unit free to rotate with respect to the housing.

3. The ultrasonic-rotary composite atomization mechanism according to claim 2, wherein two ball bearings are respectively disposed at two ends of the ultrasonic unit.

4. The ultrasonic-rotary composite atomization mechanism according to claim 1, wherein the dynamic unit includes a permanent magnet disposed in the ultrasonic unit and a brushless motor magnetic coil disposed in the housing.

5. The ultrasonic-rotary composite atomization mechanism according to claim 4, wherein a brushless motor contact is disposed in the housing, penetrating the housing, exposed from the housing, and electrically connected with the brushless motor magnetic coil.

6. The ultrasonic-rotary composite atomization mechanism according to claim 1, wherein the ultrasonic unit includes a column and a protection shell sleeving the column, and wherein an accommodation room is formed between the column and the protection shell for accommodating the vibration member, and wherein the material supply channel penetrates the column with the entrance and the exit respectively formed at two sides of the column.

7. The ultrasonic-rotary composite atomization mechanism according to claim 6, wherein O-rings are respectively disposed at two sides of the vibration member and between the column and the protection shell to make the accommodation room airtight.

8. The ultrasonic-rotary composite atomization mechanism according to claim 6, wherein the protection shell includes an upper protection shell and a lower protection shell, which can be screwed together.

9. The ultrasonic-rotary composite atomization mechanism according to claim 8, wherein a water-proof ring is disposed between the upper protection shell and the lower protection shell.

10. (canceled)

11. The ultrasonic-rotary composite atomization mechanism according to claim 1, wherein the vibration member involves a piezoelectric ceramic element.

12. The ultrasonic-rotary composite atomization mechanism according to claim 11, wherein a rotary electrode is disposed between the housing and the ultrasonic unit and electrically connected with the piezoelectric ceramic element.

13. The ultrasonic-rotary composite atomization mechanism according to claim 1, wherein the vibration-rotation cup includes an inner surface connected with the exit.

14. The ultrasonic-rotary composite atomization mechanism according to claim 13, wherein a contour of the inner surface is a hemisphere or a cone.

15. The ultrasonic-rotary composite atomization mechanism according to claim 13, wherein the inner surface includes a plurality of stripes.

16. The ultrasonic-rotary composite atomization mechanism according to claim 1, wherein the housing includes an airflow guiding device thereinside, and the airflow guiding device includes an air nozzle facing the outlet.

17. The ultrasonic-rotary composite atomization mechanism according to claim 1, wherein the housing includes an upper housing and a lower housing, which can be screwed together.

18. The ultrasonic-rotary composite atomization mechanism according to claim 17, wherein a water-proof ring is disposed between the upper housing and the lower housing.
